(19) United States
(12) Patent Application Publication
(10) Pub. No.: US 2005/0114262 A1
(43) Pub. Date: May 26, 2005

(54) Payment processing method and system using a peer-to-peer network

(75) Inventors: Charles K. Howard, Somerville, MA (US); Olufemi Omojola, Boston, MA (US); John Fallon, Andover, MA (US)

Correspondence Address: FISH & NEAVE IP GROUP;ROPES & GRAY LLP, ONE INTERNATIONAL PLACE, BOSTON, MA, 02110-2624, US

(73) Assignee: VehicleSense, Inc., Cambridge, MA (US)

(21) Appl. No.: 10/824,681

(22) Filed: Apr. 15, 2004

Related U.S. Application Data
(60) Provisional application No. 60/463,078, filed on Apr. 15, 2003.

(51) Int. Cl. G06F 17/60; G06F 15/173

(52) U.S. Cl. 705/40; 709/224; 709/223

(57) ABSTRACT

Method of processing payments for goods and services using electronic payment via a peer-to-peer network includes an order for the relevant goods or services being placed by a purchaser using a payment request terminal. The payment request terminal conveys purchaser payment information to a purchase request peer within the network. In response to the conveyed information, the purchase request peer locates within the network a payment-processing peer with the ability to generate a charge against a specified account via a payment-processing terminal. The purchase request peer forwards the information through the network (via zero or more message-passing peers) to the payment-processing peer. The payment-processing peer attempts to generate the charge, and then returns the result of the attempt (successful or unsuccessful) to the purchase request peer and any other peers that have registered an interest in this information. The purchase request peer then provides this information to the payment request terminal if necessary.

### CROSS-REFERENCE TO RELATED APPLICATIONS

This application incorporates by reference in entirety, and claims priority to and benefit of, U.S. Provisional Patent Application No. 60/463,078, filed on Apr. 15, 2003.

### BACKGROUND

There are a large number of goods and services that in general are inaccessible to electronic payment techniques because of difficulties in creating, maintaining, utilizing the infrastructure required. In typical instances, these goods and services involve payment amounts that are small and location-specific, making it difficult for electronic payment techniques (such as credit cards) to be utilized. These same electronic payment techniques have gained wide acceptance in permanently connected networks such as the Internet, where the server computers that accept payment requests are connected to the infrastructure to authorize these payments via relatively-expensive but highly-reliable communications channels, as well as in retail environments where the expense of a POTS (Plain Old Telephone Service) line which provides a reliable communications channel to an authorization service can be justified.

However, there are a large number of goods and services for which neither of these options is viable from a cost perspective, examples of which are parking meters and vending machines, but where the benefits to the consumer from the convenience of electronic payment options would be vast. In addition, the provider of the goods and services would gain from the reduced reliance on cash as an added safeguard against fraud and theft, and the providers of the electronic payment methods would benefit from increased penetration into new markets. There is therefore a need for an improved method and system for processing payments for goods and services.

### SUMMARY OF THE INVENTION

To enable processing of payments in the contexts described above, such as, without limitation, parking meters, vending machines, etc., the invention, in one embodiment, includes a method of processing payments using at least a portion of a network of data processing peers, the method including receiving, by a peer, a payment request from a user; the peer receiving the request then dynamically selects a peer belonging to the network, the selected peer being suitable for processing the payment request; the peer that receives the payment request from the user conveys information associated with the user and information associated with the payment to the selected peer; and, in response, the selected peer launches an attempt to debit an account associated with the user, based at least partially on the conveyed information.

According to one practice, the dynamic selection of a peer as the suitable peer is performed based on a metric. The metric include, without limitation, route length (measured, for example, in terms of physical distance, number of hops on the network, or other similar measure), route latency (data transfer or peer processing delays), data transmission speed, peer availability, cost overhead associated with a peer (for example, a peer may include a higher fee for implementing the payment processing than another peer), and a combination thereof.

According to one practice, the dynamic selection of a suitable peer includes sending, by the peer receiving the payment request from the user, of a ping—a discovery or exploratory signal or message—to one or more peers on the network with which the receiving peer is configured to communicate with. The ping message solicits a response regarding, among other things, availability or the pinged peer and capability of the pinged peer to process the payment request. In one aspect, in response to the pinging, the pinged peer determines whether a record exists of a prior request by the user. If a record exists, the pinged peer determines whether a characteristic of the record provides sufficient justification for the pinged peer to authorize the payment request, that is, response positively to the payment request.

According to one practice, if the pinged peer declines, for whatever reason, to process the payment request, the pinged peer attempts to locate an alternate peer on the network available, capable, and willing to process the payment request. If the pinged peer's attempt to locate the alternative peer is successful, the pinged peer responds to the receiving peer (the peer receiving the initial request from the user) the information, including the route, associated with the alternative peer. According to one embodiment, the peer receiving the initial request from the user selects itself as the suitable peer for processing the payment.

According to one aspect, the method includes alerting the user about success or failure of the attempting by the selected peer. In one practice, if the attempt by the selected peer to generate a charge against the user's account is successful, a good, a service, a privilege, or a right is granted to the user. In one embodiment, the selected peer reports to a monitoring peer on the network at least a portion of the conveyed information and information about success or failure of the attempt to generate the charge. In one aspect, the monitoring peer stores the reported information at a data storage repository.

According to one embodiment, the information to the selected peer is first relayed by one or more message-passing peers, acting as intermediary peers, before reaching the selected peer. In one practice, the selected peer attempts to locate a payment processing service, generally outside of the network but not necessarily so, available, capable, and willing to process execute a charge/debit against an account associated with the user. The account may belong to the user or it may belong to another party granting the user access/withdrawal privileges. Examples of payment processing services include, without limitation, a combination of a credit card processing center, a bank, or any other financial transaction clearinghouse.

According to various embodiments, the network of peers include parking meters, vending machines, utility meters at residential or other real estate properties, fuel pumps at fuel stations, etc. According to various embodiments, the network of peers may be interconnected by wired links, wireless links, or a combination thereof. The peers may communicate over public channels, or more typically, over private channels or secure channels. Various modalities for secure transmission of data may be employed by the methods and systems described herein; for example, authentication and encryption may be used to implement various embodiments of the invention.

In one embodiment, the invention is directed at a payment processing method using a network of data processing peers that includes a peer receiving a payment request from a user; the peer, based at least on cached (or otherwise stored) information about availability and service competency of the peers, selects a suitable peer on the network to process the payment request; the peer conveys the user's information and the payment information to the selected peer; and the selected peer attempts to debit an account associated with the user, based at least partially on the conveyed information. In one aspect, the methods and systems described herein update the stored information about the availability and competency of the peers when (or after) the selected peer responds to the payment request. In particular, the stored information is updated, according to one aspect, when a result is reached, positive or negative, regarding the payment request by the user. Other updating schemes, such as periodic updates, real-time updates, updates according to dynamically-generated schedules, etc. can be employed.

The updated information is used by the peer for future payment requests. By the competency of the peers what is meant includes whether they are capable and/or willing to perform a certain requested service. For example, if a particular peer has in the past denied a certain request type, then information is stored reflecting this fact for future reference. In one practice, the peer managing and/or referring to the stored information broadcasts the updated information to at least one other peer on the network, so the one other peer can make use of the updated information. In one practice, the stored information is updated to reflect an addition of a peer to the network. In another practice, the stored information is updated to reflect a deletion of a peer from the network. The deletion of the peer may be temporary (for example, while the peer is repaired after a failure), or it may be permanent. Similarly, addition of a peer may be temporary (for example, while the peer is substituting another peer on the network), or it may be permanent (for example, due to network expansion).

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIGS. 1A and 1B are block diagrams illustrating general and more specific embodiments of a peer-to-peer network that enables electronic payment.

FIG. 2 is a block diagram illustrating an embodiment of a peer.

FIG. 3 is a flow diagram of a routine for handling a payment request.

FIG. 4 is a flow diagram for discovery of required services by a peer within the network.

FIG. 5 depicts an embodiment of the invention including a network of parking meters.

### DETAILED DESCRIPTION OF THE ILLUSTRATED EMBODIMENTS

The present invention provides a method and system for purchasing of goods and services using electronic payment via a peer-to-peer network. This allows for dynamic and robust routing of a payment request when one or more of the peers in the network fail, are unable to process the payment request, or are otherwise not available. The user gains increased convenience by increasing the range of goods and services that accept electronic payment; the provider of the goods and services benefits from the increased ease with which their product can be purchased.

The systems and methods described herein may employ a number of devices, according to various embodiments. For example, a peer includes a data processing unit on the network (or equivalently, belonging to the network, or being of the network) and may be a device capable of participating in a data communication exchange, as a source of a message, a receiver of the message, or as a message transfer agent relaying the message between another set of peers.

A payment request terminal (PRT) is another device that is typically used by the systems and methods described herein to collect payment information from a user and forward the collected information to one or more peers on the network. The PRT can be connected to a peer using a wired or wireless communication channel. The PRT may include a user interface to interact with the user, instructing the user on steps to follow to make a payment request, and/or informing the user of the status of the request.

A purchase request peer (PRP) is another device used by the systems and methods described herein. Typically, a PRP includes a peer that collects payment and user information from the PRT and generates a payment request message to be broadcast (or somehow conveyed) to the other peers on the network.

A message-passing peer (MPP) is another device that may be used in various embodiments of the systems and methods described herein. An MPP typically includes a peer belonging to the network that relays the message between two or more other peers; in other words, an MPP serves the role of, among others, an intermediary peer relaying data between two or more other peers.

A payment-processing peer (PPP) is another device employed by the systems and methods described herein, typically to receive the payment request from a PRP. In response to the payment request, the PPP typically attempts to generate a charge, that is, debit an account associated with the user, by accessing a payment-processing service. In certain embodiments, the PPP authorizes a payment request (i.e., responds positively to the request), if it finds a prior record associated with the user indicating a healthy history of payment requests. This authorization may be issued by the PPP even without accessing a payment processing service; it may be based on information available to the PPP.

A purchase monitoring peer (PMP) includes a peer that the systems and methods described herein may optionally employ to monitor a payment request result and/or perform additional processing on the payment request. In certain embodiments, the PMP may archive the result or results of one or more payment requests associated with one or more users, for future reference or retrieval.

A subset of the peer types described above may be “smart” in that they may be configured (through preprogramming or by being equipped with an artificial intelligence capability or other methods known in the art) to robustly and dynamically determine a data communication route to any other peer in the network.

One embodiment provides a method and system for paying for goods and services via a network of self-organizing peers. The peers within the network may have different capabilities that are available to the providers of the goods and services. A user with an acceptable form of electronic payment makes a payment request via an appropriate PRT that is in communication with the network via a PRP. The PRP selects a suitable PPP on the network with the capability to generate a charge against the user's electronic payment modality, that is, the selected peer attempts to debit an account associated with the user or debit an account which the user is authorized to draw funds from.

The suitable peer may be determined by a number of different metrics; for example, and without limitation, route length, route latency, data transmission speed, peer availability, cost overhead associated with a peer, and a combination thereof, may be used in selecting a suitable peer on the network to process the payment request. In one embodiment, the closest PPP in terms of distance from the PRP is deemed as the suitable peer. The electronic payment information (such as account information and charge amount) is then forwarded to the PPP through the network via zero or more MPPs. In a typical embodiment, the user enters a unique identifier, such as a password or personal identification number (PIN) to identify himself or herself to the network. Other unique identifiers may be used in lieu or, or in addition to, a password or PIN. For example, and without limitation, a signature, a fingerprint, an iris scan, a retinal scan, voice, or any biometric signature may be employed in identifying the user.

Upon receiving the payment request, the PPP attempts to generate the charge, and then reports a result of the attempt to the PRP, as well as any PMP that may have requested a notification of such payment requests. As an example, such a PMP may serve as a storage repository that keeps track of requests, and their respective successes and failures, possibly for future reference and/or retrieval. In one embodiment, the PPP accesses a database of prior payment requests to determine if a prior payment request record exists of the user. If a record exists, the PPP then makes a determination as to whether the prior record provides sufficient grounds to authorize the current payment request by the user. For example, if the user has, on one or more previous occasions, submitted one or more successful payment requests, perhaps for an amount greater than the current request (but not necessarily so), then the PPP may authorize the current payment request, even without communicating with a payment processing service. In this fashion, the systems and methods described herein provide the user the ability to build a “credit” history associated with the network, gradually becoming more and more creditworthy as more and more payment requests by the user are successful. The ability of the network of peers to coordinate the processing of payments in this fashion is an aspect of the self-organization of the network and the peers belonging to the network.

Upon receiving the response, the PRP may return this information to the PRT that generated the original request. In addition, other actions may be taken, including providing the requested goods, services, privileges, and rights to the user if the response was positive, or displaying error information to the user if the response was negative or if the request could not be completed. An example of a privilege is, for example, when the user has requested time at a parking meter. Upon successful processing of the user's payment request, the user is granted the privilege of using a designated parking spot to park his or her vehicle for a predetermined length of time.

In one embodiment, the peer-to-peer network is created between geographically separated devices that accept payment in exchange for a specific good, service, privilege, right, or a combination thereof; without limitation and as mentioned earlier, one example of such a network is a network of parking meters. The peers within the network are interconnected using communication links; these links could be wireless or wired.

One embodiment of a wireless peer-to-peer network uses radio frequency signals for communication and includes self-organization. In an exemplary embodiment, self-organization refers to a peer sending another peer a message; the message may pass between zero or more intermediary peers (MPPs) belonging to the network, as determined by the network either in real-time or at predetermined intervals which may or may not be periodic; and there may be multiple routes between any two peers, where each route includes a sequence of other peers that can relay the message. The network includes peers that, according to various embodiments, may all directly or indirectly communicate with each other; however, in general, the ability to communicate does not translate into a requirement to communicate. In a typical embodiment, the majority of peers do not necessarily communicate directly to each of the other peers.

In addition, the network may include peers having distinct, overlapping or non-overlapping capabilities; for example, distinct peers may offer distinct services to other peers on the network. Moreover, a particular peer-to-peer network may be a sub-network of a larger system of peer-to-peer networks connected across a WAN, a LAN, or other data communication infrastructure known in the art. The data transfer protocols used by the peers may include any of the commonly-known protocols, such as TCP/IP. Data transfers between and among peers, as well as between any peer on the network and a device outside of the network may include encryption, secure socket layer (SSL) or other secure data tunneling, authentication, or any of the known security protocols known in the art.

In a specific embodiment, payment is accepted for a specified good or service; the price may be fixed in advance or dynamically generated. For example, if the user has a history of purchasing goods and/or services, the vendor of the goods and/or services may grant the user a discount or other benefit. When a user wishes to purchase the good or service, the user can choose to make a payment request using any of a number of acceptable electronic payment options. This payment request may include identifying account information and payment information. The request may also include a unique identifier associated with the user, such as a password or PIN, as mentioned previously.

The payment request is collected using a PRT, which may be any device with the ability to collect the payment request information from the user. In one embodiment the PRT is a credit card reader built into a retail vending machine, and the user presents a credit card to pay; in another embodiment the PRT could be a Bluetooth communications interface, and the user activates a Bluetooth-enabled wireless phone to pay. The PRT may be an integral part of a peer belonging to the network; that is, there may be a physically-wired connection or the PRT may occupy the same housing as the peer; one embodiment of this is a credit card reader built into a parking meter.

The PRP that receives the payment request from the PRT attempts to locate a PPP on the network with the capability to generate the requested charge against the user's account; the determination of the route may be done in real time or using cached information (such as a record from a previous request by the user). A message containing the payment request is generated and sent to the PPP through the network. The actual path that the message traverses (including the sequence of MPPs that relay the message) may differ from the determined route, depending on the design of, and conditions prevailing over, the peer-to-peer network. Another aspect of the self-organizing ability of the peers on the network is their ability to robustly and dynamically select a suitable peer for processing the payment and routing the user's information (along with payment information) to the selected peer.

The PPP attempts to generate the requested charge, and then sends a message to the PRP via zero or more MPPs (not necessarily using the same route through which the payment request arrived from the PRP to the PPP) with the result: acceptance of the specified amount or a rejection (possibly with a description of the error that occurred and other additional useful information). In addition, the PPP may notify zero or more PMPs about the result (for supervisory and/or archival purposes, for example).

When the PRP receives the return message, it provides this information to the PRT (if it is necessary) and the PRT may forward a message or confirmation data to the user. The PRT then may forward a message to other devices it may be in communication with that may then take action based on the results; such actions may include dispensing product (in a vending machine embodiment) or providing time (in a parking meter embodiment).

In one embodiment, the PRP chooses a PPP based at least partially on stored information about the availability and/or competency of the peers on the network. For example, and without limitation, the stored information may indicate that a particular peer has, for previous payment requests, denied requests of a certain type. Using this information, the PRP may decide to avoid requesting service from the PPP for that particular type. When, or after, a payment request is processed, successfully or unsuccessfully, the stored information may optionally be updated to reflect any new salient information regarding the availability and/or competency of the peers on the network. By competency, what is meant includes, for example, whether a particular peer is configured or willing to process a particular payment type. Updated information about the availability and/or competency of the peers may then be broadcast to one or more other peers on the network.

In one aspect, the information may be updated to include information about addition of a peer to the network, subtraction of a peer from the network, or both. The peer-to-peer network of the methods and systems described herein is, in one embodiment, scalable; that is to say, the network is configurable to have peers added to or subtracted from it. The stored information can readily reflect this, and be used by the PRP to process the payment request.

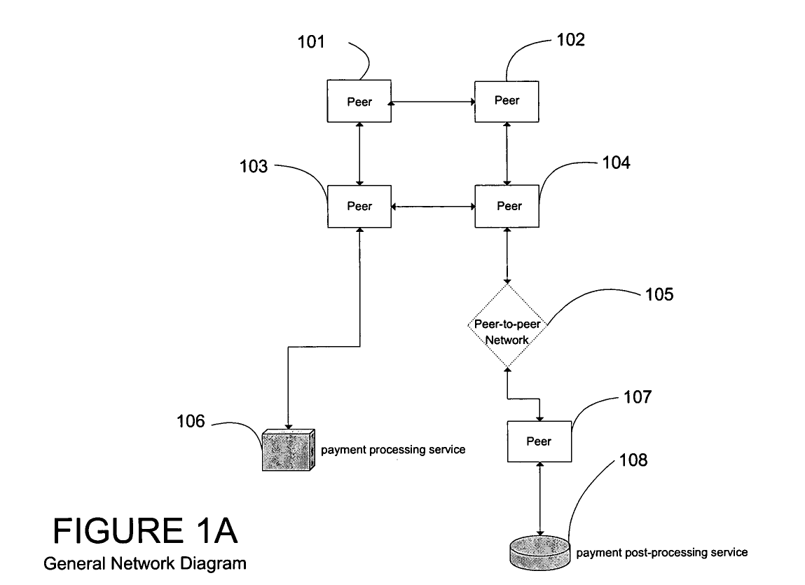

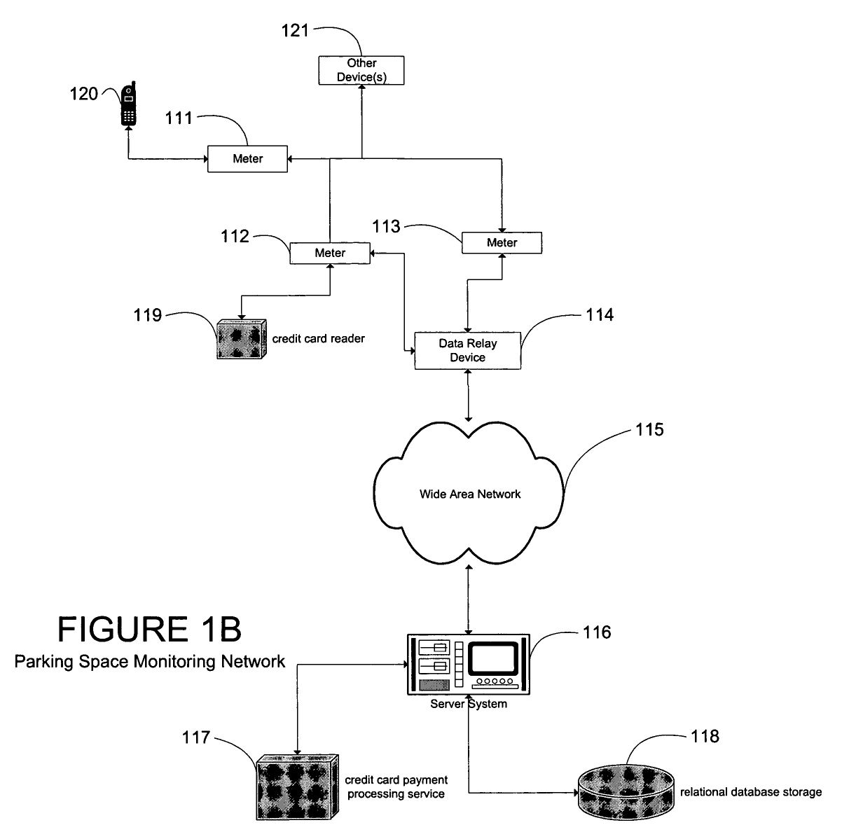

Turning to FIGS. 1A and 1B, embodiments are shown to illustrate peer-to-peer networks that enable electronic payment. FIG. 1A illustrates a general network that includes a number of peers 101, 102, 103 and 104, that are in direct or indirect communication with each other and with all or part of the rest of the peer-to-peer network, 105. In this diagram, peer 101 may send a message to any other peer in the network by routing the message through any other set of peers; as an example, a message from peer 101 to peer 103 may go directly from 101 to 103, or indirectly through peers 102 and 104 to 103. One skilled in the art would appreciate that the decision about which route any particular message should take can be pre-computed or decided in real-time based on the availability of particular peers, using network data routing principles.

In addition, specific peers may offer services to the network as a whole, such as a payment processing service 106 (which allows certain electronic payments to be processed). Peer 102 may request a payment using an electronic payment option accepted by 106 by sending an appropriate message to peer 104 (through peer 103); peer 104 may then access the payment processing service to fulfill the original payment request. In that instance, peer 102 is serving as a PRP, peer 103 as an MPP and peer 104 as a PPP. This payment processing service may require access to an external service provider, such as a credit card verification service over a telephone line. Other services may also be available through peers within the network, such as a post-processing service 108 available via peer 107. An example of such includes a storage service that tracks all failed payment requests (employing, for example, a database). Moreover, there is a wide variety of channels and encoding schemes that could be used to communicate between the various peers, and these need not be identical; a mix of wired and wireless devices could still form a peer-to-peer network. As mentioned previously, a variety of security systems may be employed to protect data transfer between and among the peers on the network, such as those described in Bruce Schneir, Applied Crytpography (Addison-Wesley 1996).

A specific embodiment of such a system is illustrated in FIG. 1B, in the form of a parking space management system. The peer-to-peer network comprises a number of parking meters (111, 112, and 113), and a data-relay device (114), all interconnected via a wireless interface, a wired interface, or a combination thereof. The data relay device offers as a service a bridge to a wide-area network 115 (such as the Internet) and through this bridge communicates with a server system 116 that provides an interface to an online credit card payment processing service 117 and a relational database storage system 118. A parking meter may include a built-in PRT, such as a credit card reader 119 on meter 112, or a Bluetooth communication device 120 on meter 111 that can communicate with a cellular phone. In this embodiment, both the parking meters and the data-relay device utilize the same wireless communication channels. In addition, the data-relay device 114 would serve as a PPP in a credit-card payment request via the WAN connection to the server system 116 and credit card payment processing service 117. It would also serve as a PMP to store requests in the relational database storage system 118. In addition, other devices 121 may be added to the system allowing for expanded capabilities beyond payment, including, but not limited to, vehicle presence monitoring, video and/or audio monitoring, and weather monitoring.

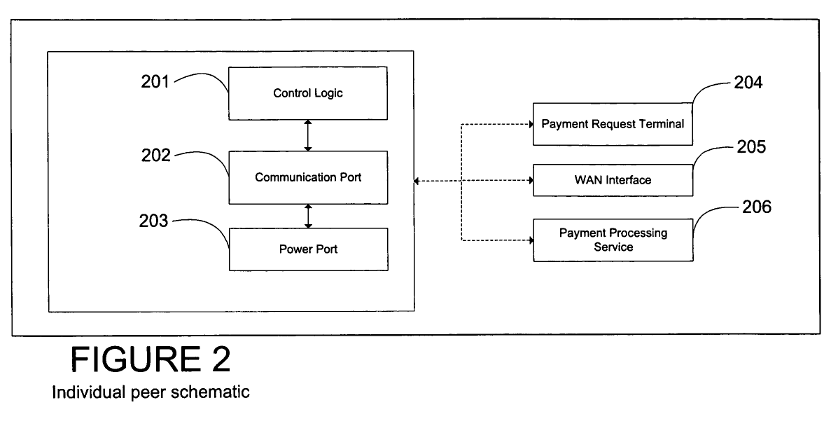

Turning to FIG. 2, a block diagram depicting a general schematic of a peer within the network is shown. The peer includes control logic 201 coupled to a communication port 202 and a power port 203; there may be more than one communication port. The control logic 201 typically controls data traffic from and to the peer by controlling a behavior of the communication port 202. This is akin to an operating system of a personal computer regulating data traffic to and from the computer for various services (such as web browsing, e-mail, multimedia streaming, etc.). So, the control logic 201 is, in one embodiment, analogous to the operating system, and may issue a series of computer commands to control the behavior of hardware to which it is operably connected. In one aspect, the control logic 201 can determine how to assign port numbers to each service rendered by the peer, and implement assignments deterministically, randomly, or by a combination thereof. The control logic 201 may be implemented in software, firmware, or both.

Aspects of the behavior of the power port 203 may also be controlled by the control logic 201. Typically, the power port includes a gateway through which a peer receives power from a source, such as a power outlet or a power line. In one embodiment, the power port may be connected to a solar-powered battery to power the peer; an example of an application of this is a parking meter, for example, that can use solar energy to power itself.

The peer may be connected—via one or more communication channels—to, among other options, a payment request terminal (PRT) 204, an interface to a wide-area network (WAN) 205 such as the Internet, or a payment processing service 206. The PRT 204 includes, in an illustrative embodiment, a user interface that can be used to prompt the user for input, and for conveying information to the user. The user interface screen may optionally include a touch screen or other commercially available monitor, such as a liquid crystal display (LCD) or a cathode-ray tube CRT). The PRT 204 may optionally include a credit card reader, which the user can use to swipe his or her credit card as part of requesting payment processing from the peer-to-peer network. In one embodiment, the PRT 204 includes a keyboard or keypad or other similar input device to provide the user with a means of entering information into the network. In one embodiment, a data entry interface similar to that used in personal digital assistants, is used to allow the user to enter information. For security purposes, the PRT 204, may optionally include a fingerprint scanner, a signature reader, an iris or retinal scanner, or other security devices used for verifying the user's identity.

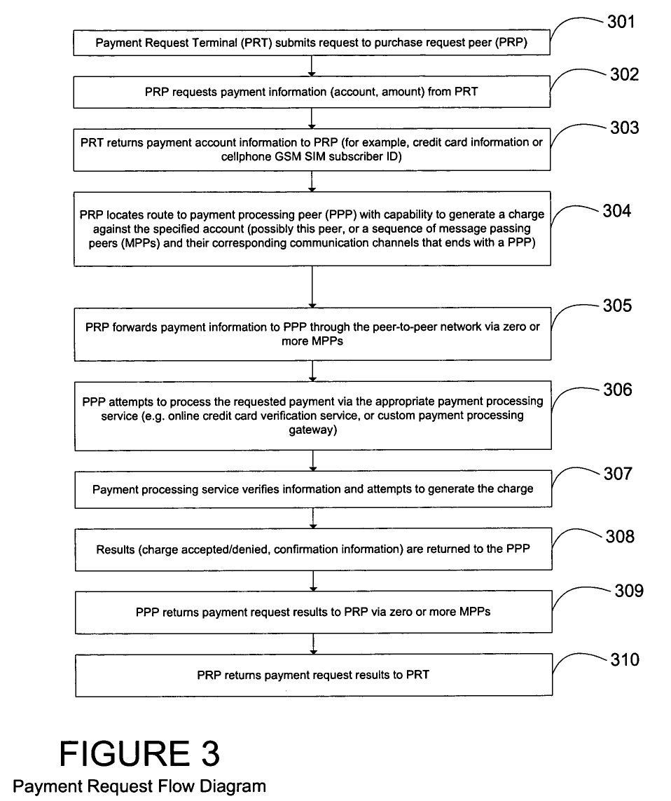

FIG. 3 is a flow diagram illustrating in greater detail one embodiment of a payment request through a peer-to-peer network. In step 301, a PRT submits a payment request to a PRP; in one embodiment, this payment request includes providing credit card information. In step 302, the PRP requests the relevant payment information from the PRT based on its type; in one illustrative embodiment this might be a credit card number and an expiry date. Alternatively, the PRP may indicate a lack of capability to process the desired payment; in another illustrative embodiment, the user wishes to purchase parking time at a designated space using a wireless phone, but the local parking operator does not accept that payment form, and the PRP (the parking meter) will indicate this to the user's phone after the phone submits the initial request. In step 303, the PRT returns the required information to the PRP. In step 304, the PRP locates a PPP that can generate the required charge. In general, it will utilize the peer with payment processing capability that best satisfies a specified metric, but alternatives may be selected at the discretion of the PRP or any other peer on the network; in fact, the PRP may also perform payment processing itself. In step 305 the PRP then inserts the payment request information into a message and inserts the message into the network with a final destination set to the PPP. In step 306, the PPP receives the request, extracts the relevant information, and attempts to generate the charge by accessing the payment processing service. In step 307, the payment processing service verifies the information and performs the appropriate actions. This payment processing service may take on a number of different forms. In one illustrative embodiment, the payment processing service includes a credit card processing service; alternatively, the payment processing service may be the user's bank, debiting an amount from the user's checking, savings, or other account at the bank.

In step 308, the payment processing service returns a result to the PPP; this result may be an acceptance, indicating that the requested payment was successfully performed, or a rejection, indicating that the requested payment did not occur. The PPP then returns the result to the PRP in step 309. In step 310 the PRP returns the result to the PRT, which may then take action; in one embodiment, the PRT is a parking meter, and if the requested payment is successfully performed, the user is granted time on the meter.

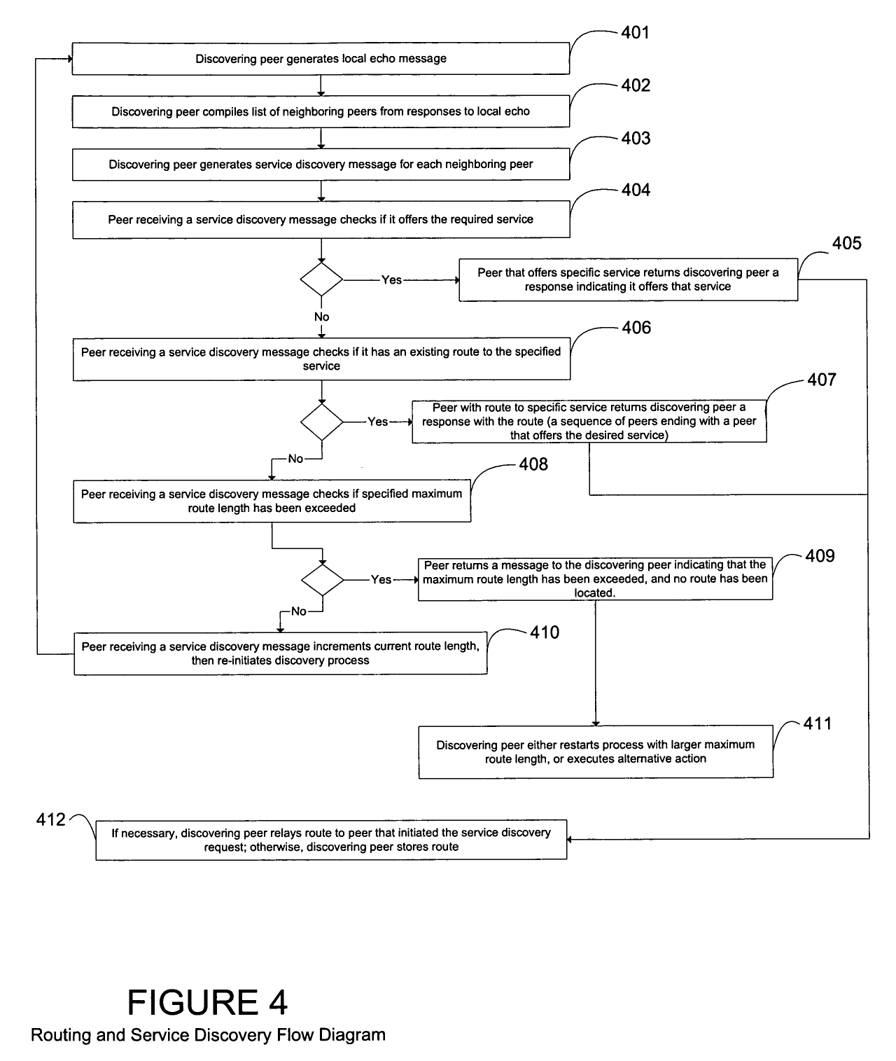

FIG. 4 depicts a flow diagram illustrating one way that the peer-to-peer network may self-organize to allow a peer on the network to access services offered by another peer belonging to the network. In step 401 a discovering peer (typically a PRP) generates a local echo message and inserts it into the network; an example of this is a ping issued by the discovering peer to the other peers on the network, requesting service (including availability). In step 402, all other peers within the network who are within direct communication range of the discovering peer reply to indicate that they are neighbors. In step 403 the discovering peer generates a service discovery message that indicates the specific service it is trying to locate and the maximum length of any acceptable route and sends it to the neighboring peers. One skilled in the art may appreciate that the discovering peer may choose to send a single service discovery message to all the neighboring peers at once, or to each neighboring peer one at a time.

Regardless of which approach is taken, in step 404 a peer receives a service discovery message, and checks to see if it offers the requested service. In step 405, the peer receiving the service discovery message does offer that service, so it sends a response to the discovering peer indicating that fact, and the discovering peer continues at step 412. In step 406, the peer that received the service discovery message does not offer the desired service, so it checks if it currently has a pre-determined route to the desired service in memory. If it does, the peer that received the service discovery message returns the route to the discovering peer in step 407, and the discovering peer continues at step 412. In an illustrative embodiment, this route includes a sequence of peer identification numbers and their communications channel information, with a peer disposed along the sequence (typically the last peer) designated as offering the desired service. In step 408, the peer that received the service discovery message checks to verify that the maximum route length has not been exceeded. If it has, in step 409 the peer that received the service discovery message returns a message to the discovering peer indicating that no acceptable route was found, and then the discovering peer continues at step 411. In step 410 the maximum route length has not been exceeded, and the peer that received the service discovery message increments the current route length and restarts the discovery process. In step 411, the discovering peer may choose to restart the discovery process with a larger maximum route length, or to perform some other action based on the unavailability of the desired service. In step 412, the discovering peer either relays the determined route to the peer that originated the service discovery message, or (if the service discovery message was originated at this peer) it stores the route. One skilled in the art would appreciate that there are a wide variety of additional optimizations that could be applied to this process, as well as other possible service discovery protocols that could be deployed, and that this is just one specific embodiment.

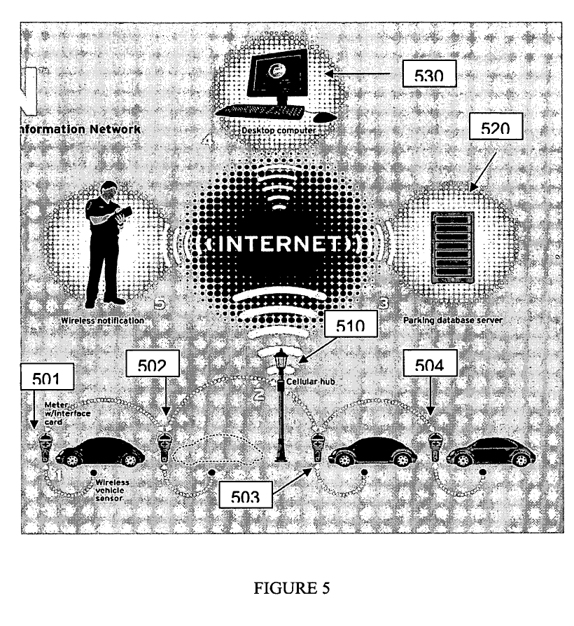

FIG. 5 illustrates a parking meter embodiment of the systems and methods described herein. Parking meters 501-504 act as peers on a peer-to-peer network 500, a portion of which is shown in the figure. The parking meters may interact wirelessly or through wired links. A wireless tower 510 acts as a hub in routing information from the parking meters to other peers on the network. For example, tower 510 can link each of the meters 501-504 to a parking database server 520 (acting as a PMP, for example) holding information about past parking records and payment requests of the user who wishes to use a parking spot associated with any of the meters 501-504. Computer 530 may be employed to coordinate and/or monitor data transmission across the network.

The contents of all references, patents and published patent applications cited throughout this Application, as well as their associated figures are hereby incorporated by reference in entirety.

Although the present invention has been described in terms of various illustrative embodiments, it is not intended that the invention be limited to these embodiments. Embodiments of the invention can be applied in many situations where geographically separated devices within reasonable proximity are interconnected using a communication medium. For example, one embodiment includes utility meters in a residential setting, which are interconnected with power lines; in one aspect, a homeowner can pre-purchase electricity from the meter with a credit card without needing to talk to a representative or to mail in a voucher.

Those skilled in the art will recognize, or be able to ascertain using no more than routine experimentation, many equivalents to the specific embodiments of the invention and the specific methods and practices associated with the systems and methods described herein. Accordingly, it will be understood that the invention is not to be limited to the embodiments, methods, and practices disclosed herein, but is to be understood from the following claims, which are to be interpreted as broadly as allowed under the law.

1. A payment processing method using a network of data processing peers, comprising:
a. a peer receiving a payment request from a user;
b. the peer dynamically selecting a suitable peer on the network to process the payment request;
c. the peer conveying user information and payment information to the selected peer; and
d. the selected peer attempting to debit an account associated with the user, based at least partially on the conveyed information.

2. The method of claim 1, including alerting the user about success or failure of the attempting by the selected peer.

3. The method of claim 1, including providing at least one of a good, a service, a privilege, and a right to the user if the attempting by the selected peer is successful.

4. The method of claim 1, including the selected peer reporting at least a portion of the conveyed information and information about success or failure of the attempting by the selected peer to a monitoring peer on the network.

5. The method of claim 4, including the monitoring peer storing the reported information at a data storage repository.

6. The method of claim 1, wherein the conveyed information is relayed to the selected peer by at least one message-passing peer belonging to the network.

7. The method of claim 1, wherein the dynamically selecting is based on a set of at least one criterion including a metric selected from the group consisting of: route length, route latency, data transmission speed, peer availability, cost overhead associated with a peer, and a combination thereof.

8. The method of claim 1, wherein the selecting includes pinging a peer on the network to request a payment processing service.

9. The method of claim 8, including, in response to the pinging, the pinged peer determining whether a record exists of a prior request by the user.

10. The method of claim 9, wherein, if the record exists, the pinged peer determines whether a characteristic of the record is sufficient for the pinged peer to authorize the payment request.

11. The method of claim 8, wherein, in response to the pinging, the pinged peer declines to provide the payment processing service.

12. The method of claim 11, including attempting by the pinged peer to locate an alternate peer likely to provide the payment processing service.

13. The method of claim 12, wherein the pinged peer, if successful in locating the alternate peer, responds to the pinging by providing a route to the alternate peer.

14. The method of claim 1, wherein the selected peer includes an entry port where the payment request is received from the user.

15. The method of claim 1, wherein the attempting by the selected peer includes locating a payment processing service external to the network of the peers to execute a debit against an account associated with the user.

16. The method of claim 15, wherein the payment processing service includes an entity selected from the group consisting of: a credit card processing service, a bank, a financial transaction clearinghouse, and a combination thereof.

17. The method of claim 1, wherein at least one of the peers includes a parking meter.

18. The method of claim 1, wherein at least one of the peers includes a vending machine.

19. The method of claim 1, wherein a pair of the peers communicate via a wired link.

20. The method of claim 1, wherein a pair of the peers communicate via a wireless link.

21. The method of claim 1, wherein a pair of the peers communicate using a network security protocol.

22. The method of claim 21, wherein the security protocol includes authentication.

23. The method of claim 21, wherein the security protocol includes a secure data tunnel.

24. The method of claim 21, wherein the security protocol includes data encryption.

25. A payment processing method using a network of data processing peers, comprising:
a. a peer receiving a payment request from a user;
b. based at least partially on stored information about availability and service competency of the peers, the peer selecting a suitable peer on the network to process the payment request;
c. the peer conveying user information and payment information to the selected peer; and
d. the selected peer attempting to debit an account associated with the user, based at least partially on the conveyed information.

26. The method of claim 25, wherein the stored information is updated upon a payment request being responded to by the selected peer, the updated information to be employed by the peer for a future payment request.

27. The method of claim 25, wherein the stored information is updated to reflect an addition of a peer to the network.

28. The method of claim 25, wherein the stored information is updated to reflect a deletion of a peer from the network.

29. The method of claim 26, including the peer broadcasting the updated information to at least one other peer on the network.
